(19) United States
(12) Patent Application Publication
(10) Pub. No.: US 2018/0248846 A1
(43) Pub. Date: Aug. 30, 2018

(54) SERVICE PROVIDING METHOD AND CONTROL DEVICE

(71) Applicant: FUJITSU LIMITED, Kawasaki-shi (JP)

(72) Inventors: Tomohiro Inoue, Kashiwa (JP); SHINGO ADACHIHARA, Kawasaki (JP); DAISUKE KUDO, Koshigaya (JP)

(73) Assignee: FUJITSU LIMITED, Kawasaki-shi (JP)

(21) Appl. No.: 15/890,519

(22) Filed: Feb. 7, 2018

(30) Foreign Application Priority Data
Feb. 27, 2017 (JP) 2017-035336

(51) Int. Cl. H04L 29/06

(52) U.S. Cl. CPC H04L 63/0218; H04L 67/10; H04L 63/0263

(57) ABSTRACT

A non-transitory computer-readable recording medium has stored therein a program for causing a computer to execute a process of providing a service for constructing a platform in a cloud and using the constructed platform. The process includes constructing a plurality of platforms in a cloud when definition information on a construction of a platform is received from a plurality of information processing devices via a network, and causing each of the plurality of platforms constructed at the constructing to include a firewall initialized to block accesses excluding one or a plurality of common access sources.

### CROSS-REFERENCE TO RELATED APPLICATION

This application is based upon and claims the benefit of priority of the prior Japanese Patent Application No. 2017-035336, filed on Feb. 27, 2017, the entire contents of which are incorporated herein by reference.

### FIELD

The embodiments discussed herein are related to a computer-readable recording medium having stored therein a service providing program, a service providing method, and a control device.

### BACKGROUND

In the recent cloud computing environment, a service has been performed for providing a platform such as hardware or an operating system (OS) on which application software is operated. Such a service is called platform as a service (PaaS). For example, in the cloud computing, a platform including a virtual system environment created by combining virtual hardware components such as a virtual server, firewall, and network with each other is constructed according to a request from a business operator using the service.

Related technologies are disclosed in, for example, Japanese Laid-Open Patent Publication No. 2016-071822.

### SUMMARY

According to an aspect of the embodiments, a non-transitory computer-readable recording medium has stored therein a program for causing a computer to execute a process of providing a service for constructing a platform in a cloud and using the constructed platform. The process includes constructing a plurality of platforms in a cloud when definition information on a construction of a platform is received from a plurality of information processing devices via a network, and causing each of the plurality of platforms constructed at the constructing to include a firewall initialized to block accesses excluding one or a plurality of common access sources.

The object and advantages of the disclosure will be realized and attained by means of the elements and combinations particularly pointed out in the claims. It is to be understood that both the foregoing general description and the following detailed description are exemplary and explanatory and are not restirctive of the disclosure, as claimed.

### BRIEF DESCRIPTION OF DRAWINGS

FIG. 1 is a diagram illustrating an example of a system configuration according to Embodiment 1;

FIG. 2 is a diagram illustrating an example of a configuration of a cloud according to Embodiment 1;

FIG. 3 is a diagram illustrating an example of a flow for constructing a platform according to Embodiment 1;

FIG. 4A is a diagram illustrating an example of a state where a communication with a platform is permitted or denied, according to Embodiment 1;

FIG. 4B is a table illustrating an example of setting information of a first firewall according to Embodiment 1;

FIG. 4C is a table illustrating an example of setting information of a second firewall according to Embodiment 1;

FIG. 5A is a view illustrating an example of an operation screen according to Embodiment 1;

FIG. 5B is a view illustrating an example of the operation screen according to Embodiment 1;

FIG. 5C is a view illustrating an example of the operation screen according to Embodiment 1;

FIG. 5D is a view illustrating an example of the operation screen according to Embodiment 1;

FIG. 6A is a diagram illustrating an example of a state where a communication with a platform is permitted or denied, according to Embodiment 1;

FIG. 6B is a table illustrating an example of setting information of the first firewall according to Embodiment 1;

FIG. 6C is a table illustrating an example of setting information of the second firewall according to Embodiment 1;

FIG. 7A is a diagram illustrating an example of a state where a communication with a platform is permitted or denied, according to Embodiment 1;

FIG. 7B is a table illustrating an example of setting information of the first firewall according to Embodiment 1;

FIG. 7C is a table illustrating an example of setting information of the second firewall according to Embodiment 1;

FIG. 8 is a flowchart illustrating an example of a service providing process according to Embodiment 1; and

FIG. 9 is a diagram illustrating a hardware configuration.

### DESCRIPTION OF EMBODIMENTS

A platform is constructed with a default state such that any access to the platform is possible, and thus, an inappropriate access may be performed.

Hereinafter, embodiments of a computer-readable recording medium having stored therein a service providing program, a service providing method, and a control device according to the present disclosure will be described in detail with reference to the drawings. The present disclosure is not limited by the embodiments. Further, the embodiments described below may be appropriately combined with each other within a scope that does not cause inconsistency.

### Embodiment 1

Description of Entire System

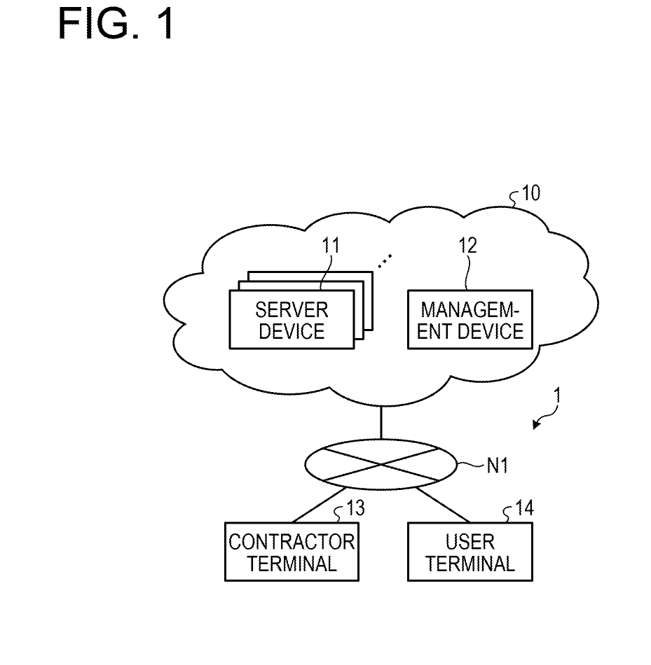

First, descriptions will be made on a schematic configuration of a system for providing a service by cloud computing (which may be referred to as a “cloud” hereinafter). FIG. 1 is a diagram illustrating an example of a system configuration according to Embodiment 1. A system 1 includes a cloud 10, a contractor terminal 13, and a user terminal 14. In the system 1 according to the present embodiment, the cloud 10, the contractor terminal 13, and the user terminal 14 are connected to each other so as to communicate with each other through a network N1. As for the network N1, any type of a communication network such as the Internet, a local area network (LAN), or a virtual private network (VPN) may be adopted, regardless of whether the communication is a wired or wireless communication.

The cloud 10 includes a plurality of server devices 11 and a management device 12. For example, the plurality of server devices 11 and the management device 12 are arranged in a data center managed by a cloud provider. In addition, the plurality of server devices 11 and the management device 12 may be distributed and arranged in a plurality of data centers.

The cloud 10 provides computer resources based on a computer network by using various types of hardware or software including the plurality of server devices 11 and the management device 12 arranged in the data center. In the present embodiment, the cloud 10 provides a service for providing an operation environment in which application software is to be operated, as a platform, by using hardware or software such as an OS or middleware. For example, the cloud provider enters into a contract with a business operator wishing to use the service provided by the cloud 10. Hereinafter, the business operator entering into the contract with the cloud provider may be referred to as a “contractor.” According to the contract with the contractor, the cloud 10 constructs a platform therein and provides the platform to the contractor via the network N1.

The contractor terminal 13 is an information processing device that is used by the contractor entering into the contract with the cloud provider. For example, the contractor develops application software to be operated in the cloud 10 by using the contractor terminal 13, and operates the developed application software in the platform of the cloud 10 so as to perform various businesses such as a World Wide Web service. For example, the contractor is a tenant who manages each business by using the cloud 10. The contractor terminal 13 is, for example, an information processing device belonging to the tenant.

The user terminal 14 is an information processing device that is used by an ordinary user using the business such as the web service by the application software operated on the platform of the cloud 10. Hereinafter, an ordinary user using the business such as the web service provided by the tenant using the cloud 10 may be referred to as a “user.” For example, the user accesses the application software operated on the platform of the cloud 10 by using the user terminal 14, so as to use various services provided by the application software.

While the example of FIG. 1 illustrates one contractor terminal 13 and one user terminal 14, the number of the contractor terminals 13 and the user terminals 14 may be any number. In addition, while the example of FIG. 1 illustrates one management device 12, a plurality of management devices 12 may be provided.

The cloud 10 provides a plurality of contractors with a service for constructing a platform in the cloud 10 and using the constructed platform. For example, the management device 12 constructs a plurality of platforms in the cloud 10 when definition information on a construction of a platform is received from the contractor terminal 13 of each of respective contractors via the network N1. When constructing each platform, the management device 12 causes the platform to include a firewall with an initialized setting to block accesses excluding one or a plurality of common access sources. Thus, the management device 12 may block accesses to the platform excluding one or a plurality of common access sources through the firewall so that an inappropriate access to the platform may be suppressed.

Configuration of Entire System

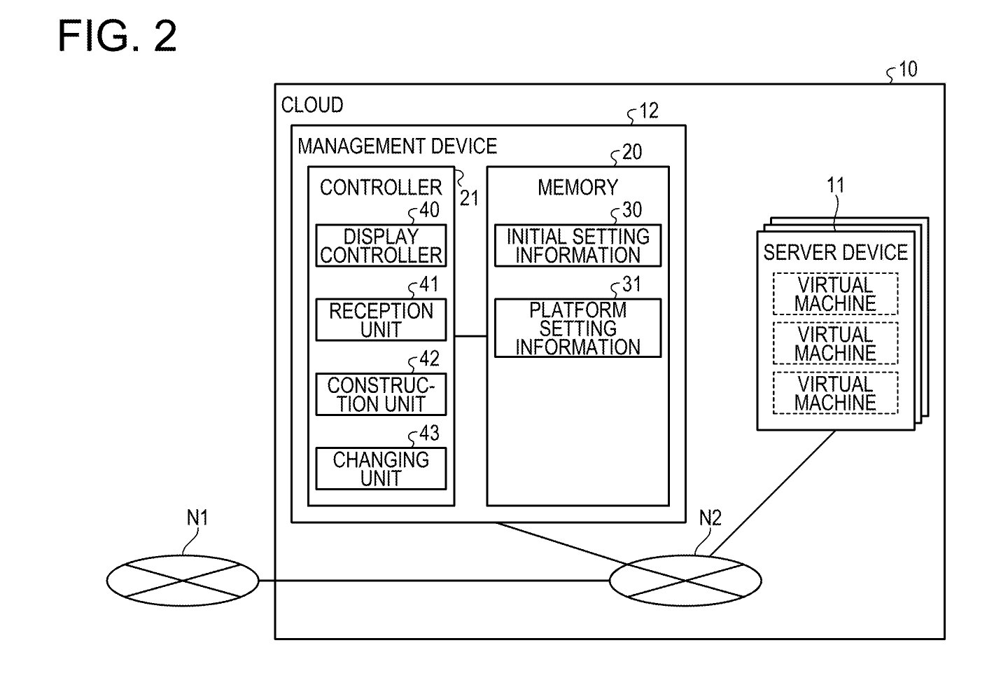

Next, a schematic configuration of the cloud 10 will be described. In the present embodiment, a case where the cloud 10 is implemented by one data center will be described as an example, for the simplification of descriptions. FIG. 2 is a diagram illustrating an example of a configuration of the cloud according to Embodiment 1. As illustrated in FIG. 2, the cloud 10 includes the plurality of server devices 11 and the management device 12.

The plurality of server devices 11 and the management device 12 are connected to each other by a network N2 provided in the data center to be communicated with each other. The network N2 is connected for communication to the external network N1 such as the Internet, and communication with the contractor terminal 13 and the user terminal 14 is possible via the network N1. While the example of FIG. 2 illustrates three server devices 11, the number of the server devices 11 may be any number. In addition, while the example of FIG. 2 illustrates one management device 12, a plurality of management devices 12 may be provided.

Each server device 11 is a physical server provided in the data center, and for example, a server computer. The server device 11 is able to operate a virtual machine implemented by virtualizing a computer using a virtualization technology. In the example of FIG. 2, three virtual machines are being operated on the server device 11. The virtual machines may function as various servers such as a firewall, a load balancer, a web server, an application (AP) server, and a database (DB) server according to middleware to be incorporated therein.

The management device 12 is also a physical server provided in the data center, and for example, a server computer. The management device 12 controls the server devices 11. In addition, the management device 12 may be a virtual machine operated on one of the server devices 11.

The management device 12 manages and operates the service provided by the cloud 10. The management device 12 is accessible from the contractor terminal 13, and constructs and provides a platform on which application software is to be operated, according to a request from the contractor. For example, the cloud 10 virtualizes various hardware resources including a network device constituting the network N2 and the server devices 11, by using the virtualization technology. The management device 12 constructs a platform including a virtual system created by combining the virtual hardware resources in the cloud 10 with each other.

Configuration of Management Device

Next, a configuration of the management device 12 will be described. As illustrated in FIG. 2, the management device 12 includes a memory 20 and a controller 21. The management device 12 may have various other known functional units of a computer such as, for example, various input devices or audio output devices, in addition to the functional units illustrated in FIG. 2.

The memory 20 is implemented by, for example, a semiconductor memory device such as a random access memory (RAM) or a flash memory, or a memory device such as a hard disk or an optical disk. The memory 20 stores an OS or various programs to be executed by the controller 21. For example, the memory 20 stores programs for executing a service providing process to be described later. Further, the memory 20 stores various data which are used in the programs to be executed by the controller 21. For example, the memory 20 stores initial setting information 30 and platform setting information 31.

The initial setting information 30 stores information on an initial setting of a platform when the platform is constructed. In the present embodiment, when a platform is constructed, an initial setting is performed to block accesses to the platform excluding one or a plurality of common access sources. The initial setting information 30 stores information such as a transmission source, a transmission destination, and a type of a communication which is not blocked but is permitted to access the platform in the initial setting. For example, the initial setting information 30 stores an address of the management device 12 which is a transmission source of the communication permitted to access the platform in the initial setting, a type or address of a server which is a transmission destination of the communication, among the plurality of servers of the constructed platform, and a type or port number of the communication. When there is a plurality of management devices 12, the initial setting information 30 stores an address of each management device 12 as an access source of the communication permitted to access the platform in the initial setting. For example, the initial setting information 30 stores an address of each of the plurality of management devices 12, a type or address of a server which is an access destination of the permitted communication among the servers of the constructed platform, and a type or port number of the permitted communication.

The platform setting information 31 stores information on various settings set for the constructed platform. For example, the platform setting information 31 stores information on the access control set for the constructed platform.

The controller 21 is implemented in the manner that, for example, a central processing unit (CPU) or a micro processing unit (MPU) executes programs stored in an internal memory device while using a RAM as a work area. Further, the controller 21 may be implemented by an integrated circuit such as an application specific integrated circuit (ASIC) or a field programmable gate array (FPGA).

The controller 21 includes a display controller 40, a reception unit 41, a construction unit 42, and a changing unit 43, and implements or executes an information processing function or operation to be described later. The internal configuration of the controller 21 is not limited to the configuration illustrated in FIG. 2, and any other configuration may be adopted as long as the configuration performs the information processing to be described later. For example, each of the process units performs transmission/reception of data with other computers via a communication unit (not illustrated). In addition, for example, each of the process units may be configured to construct a platform by receiving an operation by a manager through an input unit (not illustrated). In addition, the display controller 40, the reception unit 41, the construction unit 42, and the changing unit 43 are an example of electronic circuits such as processors or an example of processes executed by processors or the like.

The display controller 40 controls display of various pieces of information. For example, the display controller 40 controls display of various operation screens for using the service of the cloud 10.

When the contractor enters into the contract to use the service of the cloud 10, a contractor ID and a password are assigned to the contractor, and an address for accessing the management device 12 such as a URL address is notified to the contractor. When using the service of the cloud 10, the contractor accesses the management device 12 by using the contractor terminal 13.

When the access is received, the display controller 40 transmits information on various operation screens to the access source, and performs a control to cause the access source to display the operation screens. For example, when the access from the contractor terminal 13 is received, the display controller 40 causes the contractor terminal 13 to display a login screen, so as to cause the contractor ID and the password to be input and receive the login. When the login is successful, the display controller 40 performs a control to cause the contract terminal 13 to display various screens such as the operation screens. For example, the display controller 40 causes the contractor terminal 13 to display an operation screen for instructing a construction of a platform or an operation screen for performing a setting for a constructed platform.

The reception unit 41 receives various pieces of information. For example, the reception unit 41 receives information on various operations or input data received on the various operation screens, from the contractor terminal 13. For example, the reception unit 41 receives definition information on a construction of a platform. Further, for example, the reception unit 41 receives instruction information for instructing change of a setting of a constructed platform. The definition information may include system configuration information such as the number of servers to be constructed, a type of each server, and a network configuration. In addition, the definition information may be information for designating a system configuration to be constructed, from a plurality of predetermined system configurations. For example, the management device 12 stores a plurality of pieces of system configuration information which are different from each other in the number of servers to be constructed, a type of each server, and a network configuration, in the storage unit 20. The definition information may be information for designating a system configuration to be constructed as a platform, from the plurality of system configurations.

When the definition information on a construction of a platform is received, the construction unit 42 constructs a platform in the cloud 10. For example, the construction unit 42 generates virtual machines as many as specified in the definition information, in the server device 11. The construction unit 42 incorporates an OS or middleware corresponding to the type specified in the definition information into each of the generated virtual machines, so as to generate virtual machines each having a function corresponding to the specified type. For example, the construction unit 42 generates virtual machines having various functions such as a firewall, a load balancer, a web server, an AP server, and a DB server, by changing the middleware to be incorporated into the virtual machines according to the specified type. The construction unit 42 constructs a virtual network according to the network configuration specified in the definition information, and generates a virtual system in which the generated virtual machines and the virtual network are combined with each other, as a platform.

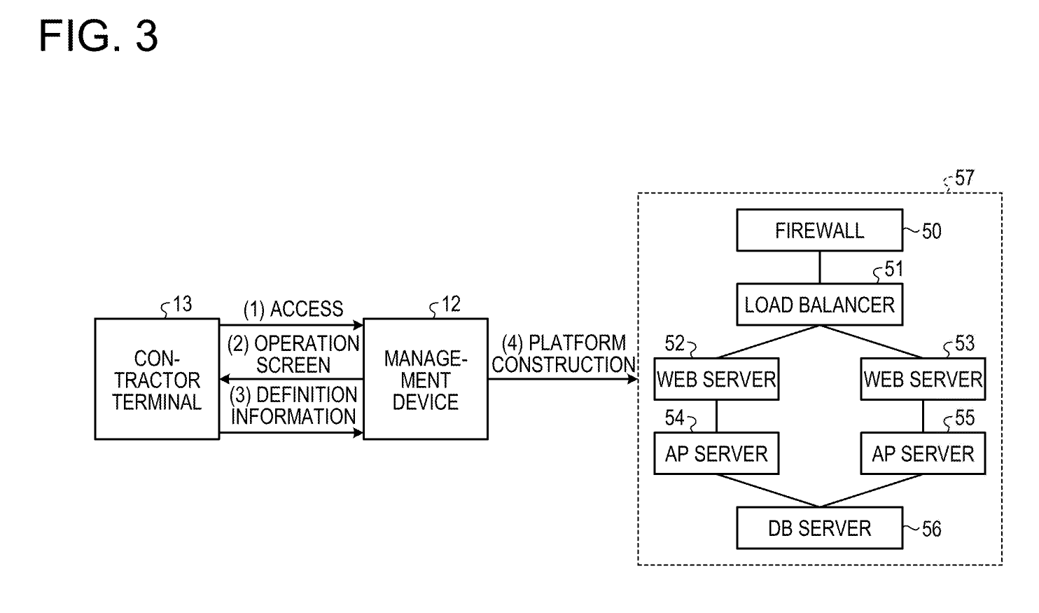

FIG. 3 is a diagram illustrating an example of a flow for constructing a platform according to Embodiment 1. When the access from the contractor terminal 13 is received ((1) of FIG. 3), the management device 12 transmits the information of the operation screens to cause the operation screens to be displayed on the contractor terminal 13 ((2) of FIG. 3). Then, when the definition information on a construction of a platform is received ((3) of FIG. 3), the management device 12 constructs a platform ((4) of FIG. 3). In the example of FIG. 3, a virtual system 57 in which one firewall 50, one load balancer 51, two web servers 52 and 53, two AP servers 54 and 55, and one DB server 56 are connected to a network is generated as a platform. Here, the platform illustrated in FIG. 3 is an example, and the present disclosure is not limited thereto. In the platform, the configuration of the system may be changed by changing the definition information. In addition, a plurality of platforms having the same configuration or different configurations may be generated. For example, the contractor may generate a platform for a management for performing a business and a platform for testing a new function, in the cloud 10.

When constructing the platform, the construction unit 42 performs an initial setting of the platform to be constructed based on the initial setting information 30. For example, the construction unit 42 performs a setting for the firewall to permit an access from the address of the management device 12 which is stored as an access source to be initialized in the initial setting information 30, and block accesses from other addresses. For example, the construction unit 42 performs a setting for the firewall to permit a communication stored as the communication permitted for access in the initial setting of the initial setting information 30, and block other communications. Thus, for example, when the cloud 10 has one management device 12, an initial setting to block accesses excluding one common access source is set for the firewall in the constructed platform. When the cloud 10 has a plurality of management devices 12, an initial setting to block accesses excluding the plurality of access sources common to the platform is set for the firewall in the constructed platform.

The construction unit 42 stores information on various settings set for each constructed platform in the platform setting information 31. For example, the construction unit 42 stores the setting information on the access control set for the firewall of the constructed platform, in the platform setting information 31.

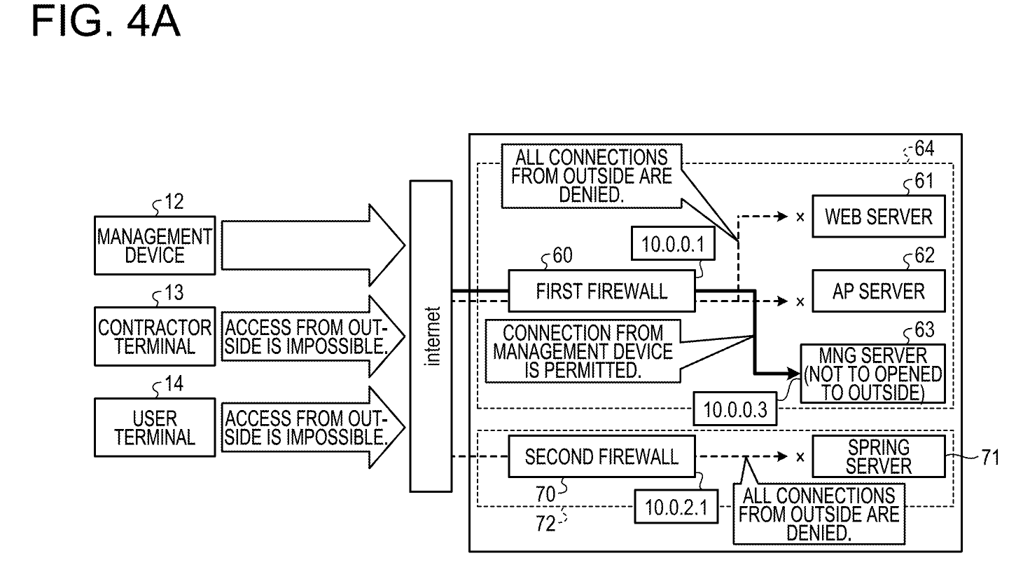

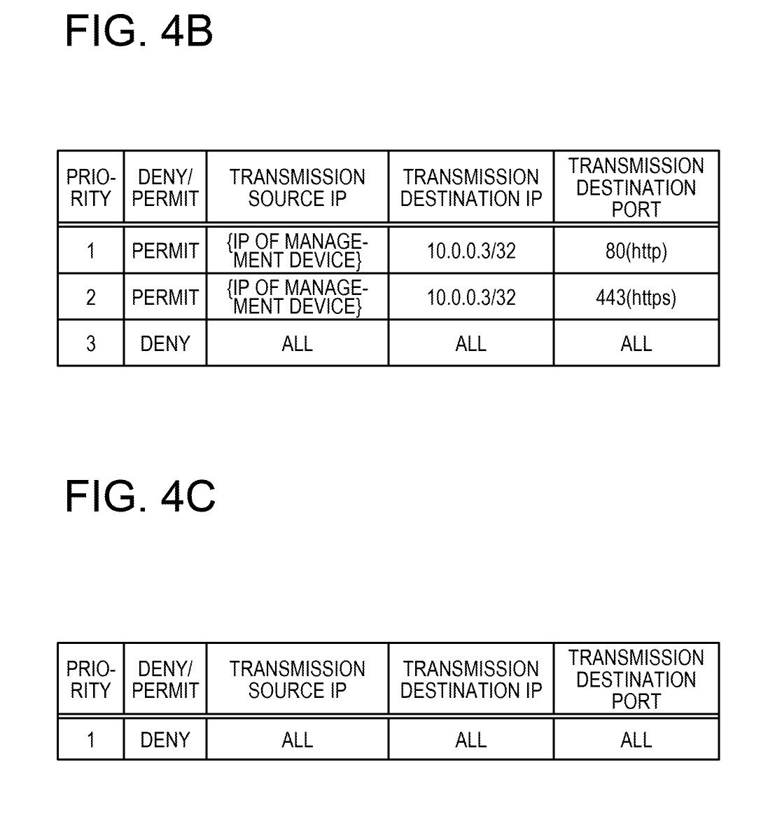

FIG. 4A is a diagram illustrating an example of a state where a communication with a platform is permitted or denied. FIG. 4A represents an example of the initial setting state of permission or denial of a communication. In the example of FIG. 4A, a virtual system 64 in which one first firewall 60, one web server 61, one AP server 62, and one management (MNG) server 63 are connected to a network is generated as a platform. Further, in the example of FIG. 4A, a virtual system 72 in which a second firewall 70 and one spring server 71 are connected to a network is generated as a platform.

The MNG server 63 controls and manages the web server 61 and the AP server 62 and is not opened to the user. The spring server 71 is, for example, a server used for input/output of data with respect to the web server 61 or the AP server 62 and is not opened to the user. It is assumed that the first firewall 60 has an Internet protocol (IP) address “10.0.0.1.” It is assumed that the MNG server 63 has an IP address “10.0.0.3.” It is assumed that the second firewall 70 has an IP address “10.0.2.1.”

FIG. 4B is a table illustrating an example of setting information of the first firewall according to Embodiment 1. FIG. 4B represents setting information of conditions for permitting or denying a communication, which is set for the first firewall 60 of FIG. 4A. The setting information has items of “Priority,” “Deny/Permit,” “Transmission Source IP,” “Transmission Destination IP,” and “Transmission Destination Port.” The setting information illustrated in FIG. 4B is an example, and other items may be added.

The item “Priority” is an area for storing priorities of the set conditions. In the set conditions, a condition having a small priority value is preferentially valid. The item “Deny/Permit” is an area for storing whether a set condition is a condition for permitting or denying a communication. In the item “Deny/Permit,” “permit” is set when a set condition is a condition for permitting a communication, and “deny” is set when a set condition is a condition for denying a communication. The item “Transmission Source IP” is an area for storing an IP address which is a transmission source of a communication. The item of “Transmission Destination IP” is an area for storing an IP address which is a transmission destination of a communication. The item “Transmission Destination Port” is an area for storing a port number of a transmission destination of a communication.

In the setting information illustrated in FIG. 4B, the priority “1” permits a communication from the address of the management device 12 controlling the construction of the platform to the IP address “10.0.0.3/32” with a port number of the transmission destination “80.” The type of the communication with the port number of the transmission destination “80” is http. Further, in the setting information illustrated in FIG. 4B, the priority “2” permits a communication from the address of the management device 12 controlling the construction of the platform to the IP address “10.0.0.3/32” with a port number of the transmission destination “443.” The type of the communication with the port number of the transmission destination “443” is https. Further, in the setting information illustrated in FIG. 4B, communications excluding the permitted communications are set to be blocked. For example, in the setting information illustrated in FIG. 4B, the priority “3” denies communications with all port numbers from all transmission sources to all transmission destinations.

FIG. 4C is a table illustrating an example of setting information of the second firewall according to Embodiment 1. FIG. 4C represents setting information of conditions for permitting or denying a communication, which is set for the second firewall 70 of FIG. 4A.

In the setting information illustrated in FIG. 4C, since there is no communication permitted in the initial setting, the priority “1” denies communications with all port numbers from all transmission sources to all transmission destinations.

The first firewall 60 determines whether a communication meets the conditions of the setting information illustrated in FIG. 4B in an order of a descending priority. When it is determined that a condition is met, the first firewall 60 permits or denies the communication according to the setting in the item “Deny/Permit.” In addition, when a communication meets a plurality of conditions, the first firewall 60 permits or denies the communication according to a condition having a relatively high priority. For example, in the example of FIG. 4B, the communication from the address of the management device 12 to the IP address “10.0.0.3/32” with the port number of the transmission destination “80” meets the conditions of the priorities “1” and “3.” However, the priority “1” is preferentially permitted for communication. In addition, in the example of FIG. 4B, the communication from the address of the management device 12 to the IP address “10.0.0.3/32” with the port number of the transmission destination “443” meets the priorities “2” and “3.” However, the priority “2” is preferentially permitted for communication. Since other communications meet the condition of the priority “3,” the communications are denied and blocked.

The second firewall 70 determines whether a communication meets the conditions of the setting information illustrated in FIG. 4C in an order of a descending priority. When it is determined that a condition is met, the second firewall 70 permits or denies the communication according to the setting in the item “Deny/Permit.” For example, in the example of FIG. 4C, all communications are denied and blocked according to the condition of the priority “1.”

As a result, as illustrated in FIG. 4A, the management device 12 may communicate with the MNG server 63 with the port numbers “80” and “443” via the first firewall 60. Meanwhile, the management device 12 is blocked from accessing the web server 61 and the AP server 62 by the first firewall 60.

In addition, the contractor terminal 13 and the user terminal 14 are blocked from accessing the web server 61, the AP server 62, and the MNG server 63 by the first firewall 60.

In addition, the management device 12, the contractor terminal 13, and the user terminal 14 are blocked from accessing the spring server 71 by the second firewall 70.

The management device 12 stores information on various settings set for each constructed platform, in the platform setting information 31. For example, the management device 12 stores the setting information on the access control which is illustrated in FIGS. 4B and 4C, in the platform setting information 31.

When the platform is in the initial setting state, the contractor accesses the management device 12 from the contractor terminal 13 to perform a login, and operates the operation screen to perform the control of the MNG server 63 through the management device 12.

When the platform is constructed, the management device 12 provides the contractor with the information on the constructed platform. For example, the display controller 40 performs a control to cause the information on the constructed platform to be displayed on an operation screen.

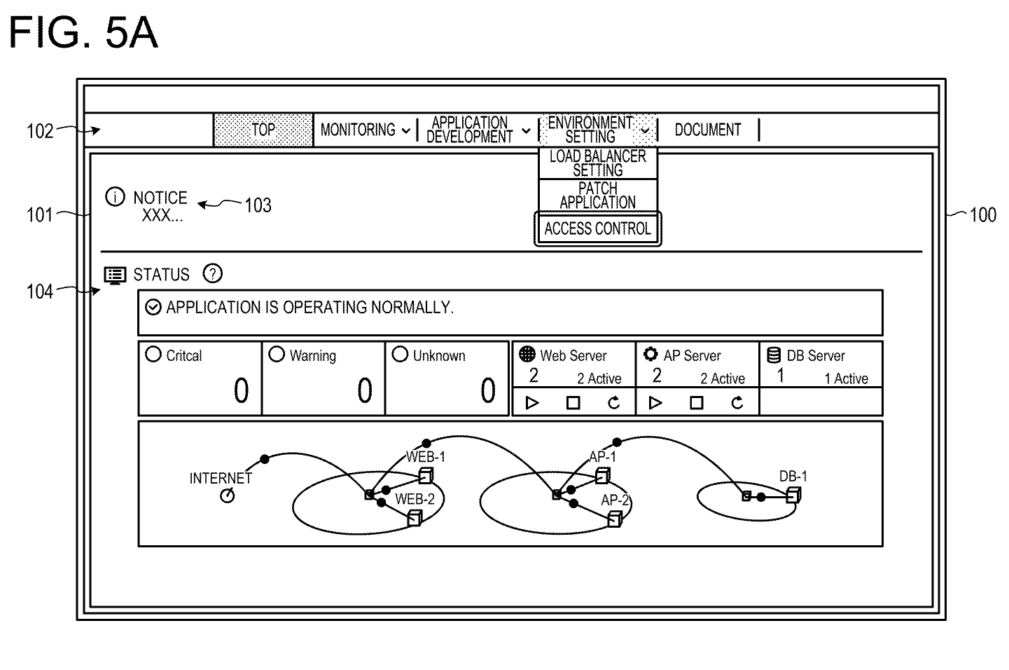

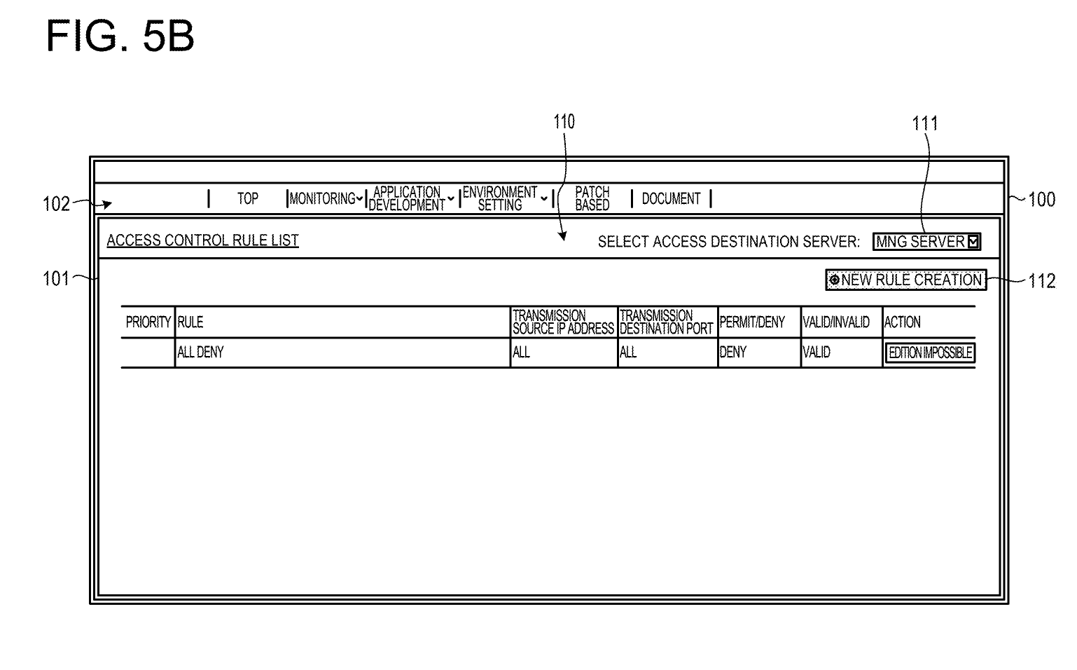

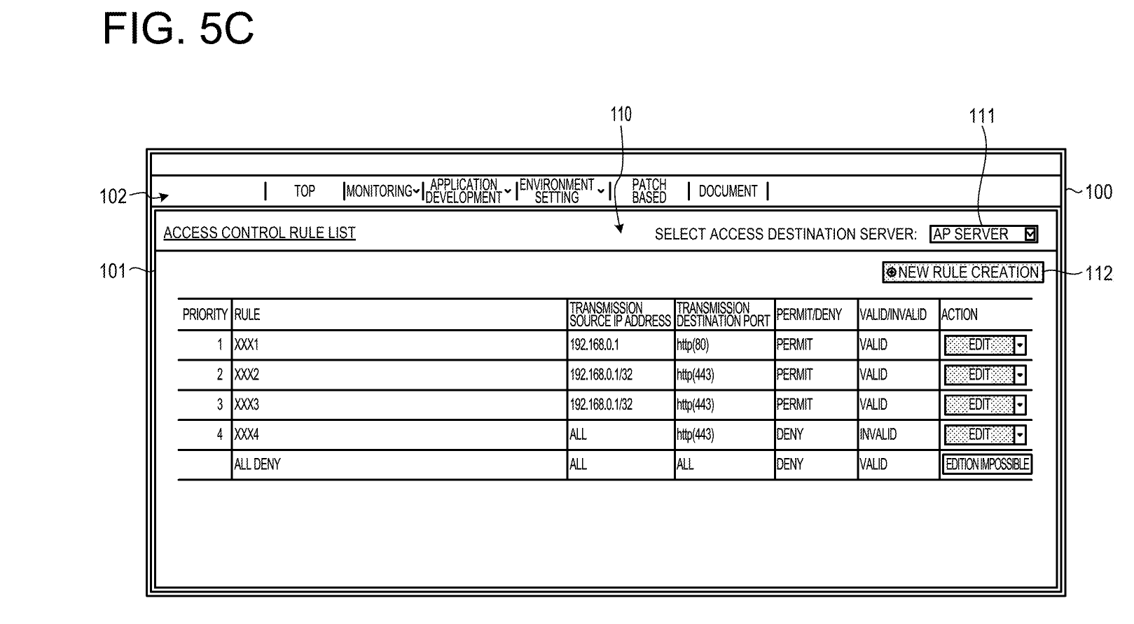

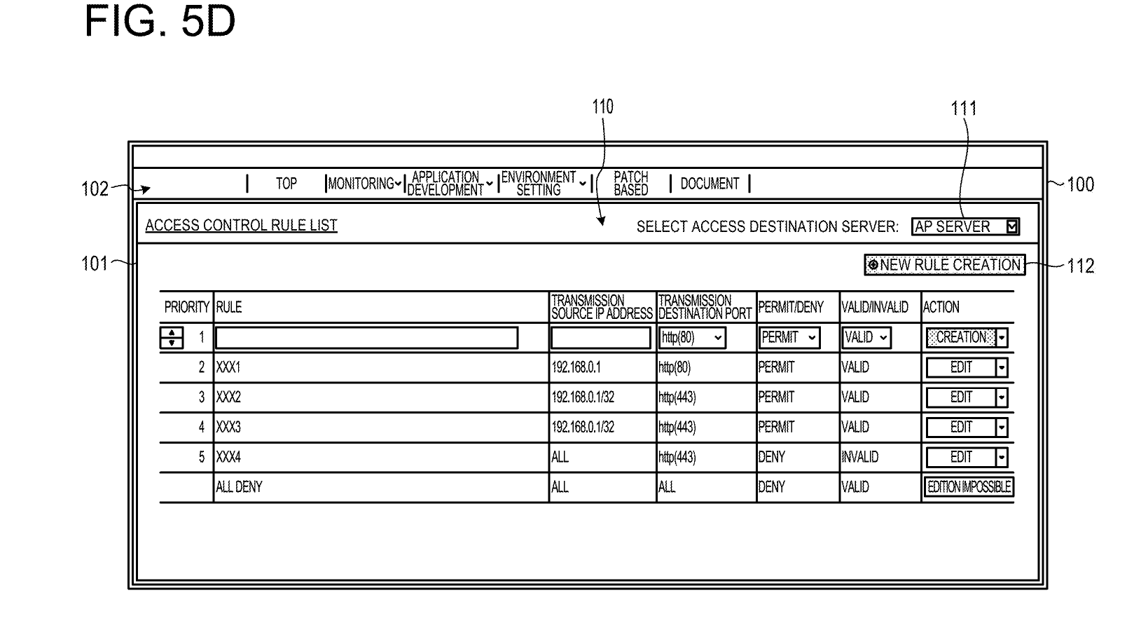

FIG. 5A is a view illustrating an example of the operation screen according to Embodiment 1. On an operation screen 100, a main area 101 for displaying various pieces of information and a menu area 102 positioned at the upper portion of the operation screen 100 are provided. The main area 101 displays a notice area 103 for displaying a notice and a status area 104 for displaying a system status of the platform.

The status area 104 displays a system configuration of the platform. In the example of FIG. 5A, the status area 104 displays types of the respective servers constituting the system and the connection relationship of the respective servers. Further, the status area 104 displays the number of occurrences of a critical problem (Critical), warning (Warning), and an unknown problem (Unknown) in the platform. Further, in the status area 104, it is possible to instruct start and stop of each server.

In the menu area 102, areas of “ToP,” “Monitoring,” “Application Development,” “Environment Setting,” and “Document” are provided. The example of FIG. 5A represents a state where the “TOP” of the menu area 102 is selected.

The management device 12 is configured such that it is possible to change the setting of the access control to the platform, on the operation screen. When changing the setting of the access control to the platform, the contractor selects the “Environment Setting” of the menu area 102 of the operation screen and selects the “Access Control” displayed as a submenu of the “Environment Setting” menu.

FIG. 5B is a view illustrating an example of the operation screen according to Embodiment 1. The example in FIG. 5B represents an example of the operation screen displayed when the “Access Control” displayed as a submenu is selected.

When the “Access Control” is selected, the display controller 40 causes a setting screen for setting blocking or permission of an access for the firewall to be displayed. For example, the display controller 40 reads the setting information on the access control, which is set for the firewall of the platform, from the platform setting information 31, and causes a setting screen 110 to be displayed in the main area 101 of the operation screen 100. The setting screen 110 has a selection area 111 for selecting a server which is a target for the access control by the firewall. When the selection area 111 is selected, the selection area 111 displays the servers constituting the system of the platform, and a server which is a target for the access control may be selected from the displayed servers. The example of FIG. 5B represents a state where the MNG server 63 is selected in the selection area 111. The display controller 40 reads the setting information on the access control, which is set for the server selected in the selection area 111, from the platform setting information 31, and causes the setting screen to be displayed in the main area 101. At this time, the display controller 40 causes the setting screen 110 to be displayed while hiding the initial setting stored in the initial setting information 30. The example of FIG. 5B represents a state where the setting screen 110 for setting blocking or permission of an access for the first firewall 60 illustrated in FIGS. 4A and 4B is displayed. As illustrated in FIG. 5B, the setting screen 110 hides the initial settings of the priorities “1” and “2” in FIG. 4B for permitting the access from the address of the management device 12 to the MNG server 63. Further, as illustrated in FIG. 5B, the setting screen 110 displays the setting of the priority “3” for denying accesses from all addresses.

Here, the management device 12 is a device that manages and operates the service provided by the cloud 10. Thus, leakage of the information of the management device 12 such as the IP address needs to be suppressed in consideration of security. Thus, the management device 12 causes the setting screen 110 to hide the address of the management device 12 permitted for an access in the initial setting for the platform. As a result, the management device 12 may suppress the leakage of the information of the management device 12 such as the IP address.

In addition, the management device 12 causes the setting screen 110 to hide the initial setting stored in the initial setting information 30. As a result, the management device 12 may suppress erroneous deletion of the initial setting.

The setting screen 110 has a new rule creation button 112 for instructing creation of a new rule, and thus, it is possible to add a setting for blocking or permitting an access by selecting the new rule creation button 112. Further, on the setting screen 110, it is possible to edit or delete a setting for blocking or permitting an access.

FIG. 5C is a view illustrating an example of the operation screen according to Embodiment 1. The example of FIG. 5C represents an example of the operation screen in a state where the AP server 62 is selected in the selection area 111, and four settings for newly permitting an access are added. The added settings may be edited by selecting “setting” in an action. FIG. 5D is a view illustrating an example of the operation screen according to Embodiment 1. FIG. 5D represents an example of the operation screen in a state where the new rule creation button 112 is selected on the setting screen 110 illustrated in FIG. 5C. When the new rule creation button 112 is selected, a line is added on the setting screen 110 so that it is possible to add a setting for blocking or permitting an access. Further, on the setting screen 110, a button 113 is displayed in the place of the new rule creation button 112 to instruct cancellation of the creation of a new rule and return from the new creation so that it is possible to cancel the creation of a new rule.

Descriptions will be made by referring back to FIG. 2. The reception unit 41 receives various pieces of operation information received on the various operation screens from the contractor terminal 13. For example, the reception unit 41 receives instruction information for instructing change of the setting of the access control for the platform from the setting screen 110.

When the instruction information for instructing change of the setting of the constructed platform is received, the changing unit 43 changes the setting of the platform. For example, the changing unit 43 sets blocking or permission of an access for the firewall of the platform according to the instruction information for instructing change of the setting of the access control. As a result, the conditions for blocking or permitting an access are changed in the platform.

The changing unit 43 stores the information on the various changed settings in the platform setting information 31. For example, the changing unit 43 stores the changed setting information on the access control in the platform setting information 31.

When developing application software to be operated on the platform, the contractor performs a setting for permitting an access of the terminal developing the application software to the platform, on the setting screen 110. For example, when developing application software to be operated on the cloud 10 by using the contractor terminal 13, the contractor performs a setting for permitting an access of the contractor terminal 13 to the platform.

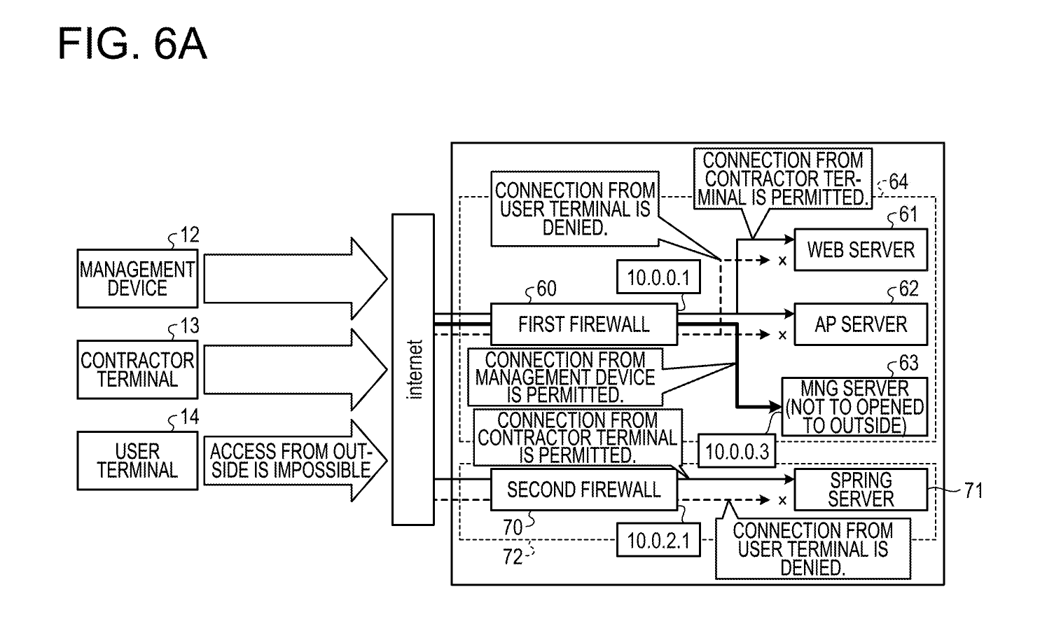

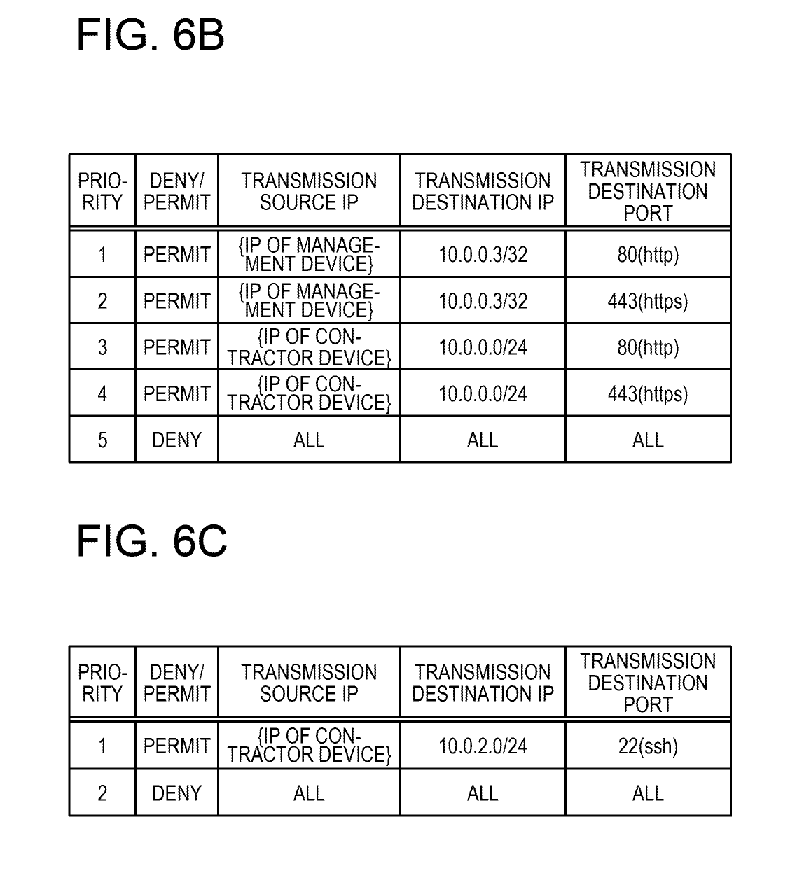

FIG. 6A is a view illustrating an example of a state where a communication with the platform is permitted or denied, according to Embodiment 1. The example of FIG. 6A represents a case where the example of FIG. 4A is changed to a setting of a development stage. FIG. 6B is a table illustrating an example of setting information of the first firewall according to Embodiment 1. FIG. 6B represents setting information of conditions for permitting or denying a communication, which is set for the first firewall 60 of FIG. 6A. FIG. 6C is a table illustrating an example of setting information of the second firewall according to Embodiment 1. FIG. 6C represents setting information of conditions for permitting or denying a communication, which is set for the second firewall 70 of FIG. 6A.

In the setting information illustrated in FIG. 6B, as for the priority “3,” a setting for permitting a communication from the address of the contractor terminal 13 to the IP address “10.0.0.0/24” with the port number of the transmission destination “80” is added. Further, in the setting information illustrated in FIG. 6B, as for the priority “4,” a setting for permitting a communication from the address of the contractor terminal 13 to the IP address “10.0.0.0/24” with the port number of the transmission destination “443” is added. Further, in the setting information illustrated in FIG. 6B, the priority of the setting for denying communications with all port numbers from all transmission sources to all transmission destinations is changed to the priority “5.”

In the setting information illustrated in FIG. 6C, as for the priority “1,” a setting for permitting a communication from the address of the contractor terminal 1 to the IP address “10.0.2.0/24” with a port number of the transmission destination “22” is added. A type of the communication with the port number of the transmission destination “22” is ssh. Further, in the setting information illustrated in FIG. 6C, the priority of the setting for denying communications with all port numbers from all transmission sources to all transmission destinations is changed to the priority “2.”

As a result, as illustrated in FIG. 6A, the management device 12 may communicate with the MNG server 63 with the port numbers “80” and “443” via the first firewall 60. Meanwhile, the management device 12 is blocked from accessing the web server 61 and the AP server 62 by the first firewall 60.

In addition, the contractor terminal 13 may communicate with the web server 61, the AP server 62, and the MNG server 63 with the port numbers “80” and “443.” Meanwhile, the user terminal 14 is blocked from accessing the web server 61, the AP server 62, and the MNG server 63 by the first firewall 60.

In addition, the contractor terminal 13 may communicate with the spring server 71 with the port number “22.” Meanwhile, the management device 12 and the user terminal 14 are blocked from accessing the spring server 71 by the second firewall 70.

As a result, the contractor may develop application software by using the platform.

When starting a business by operating the developed application software on the platform, the contractor performs a setting to permit an access from the user to the platform, on the setting screen 110. For example, the contractor performs a setting to permit an access of the user terminal 14.

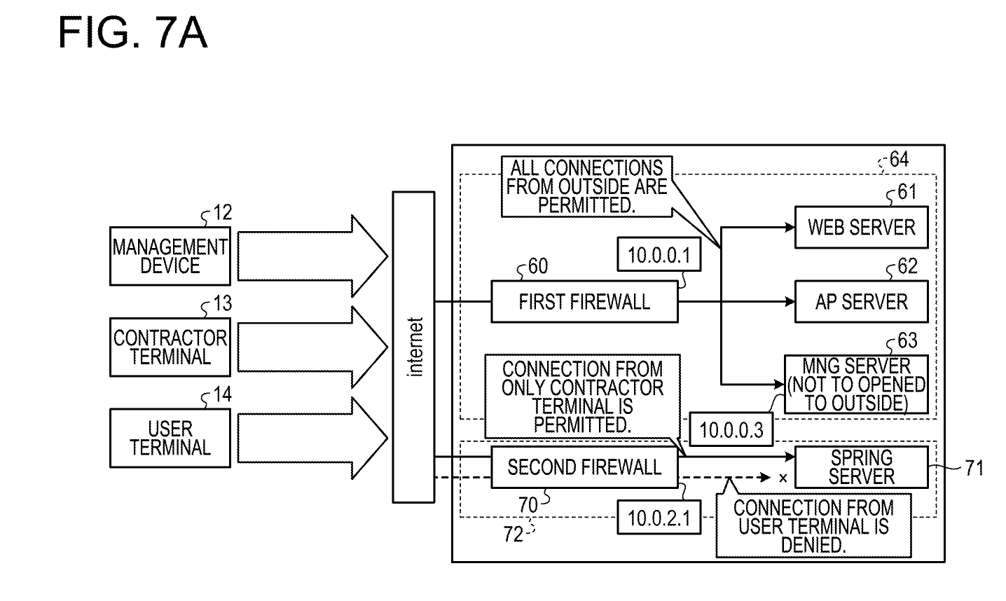

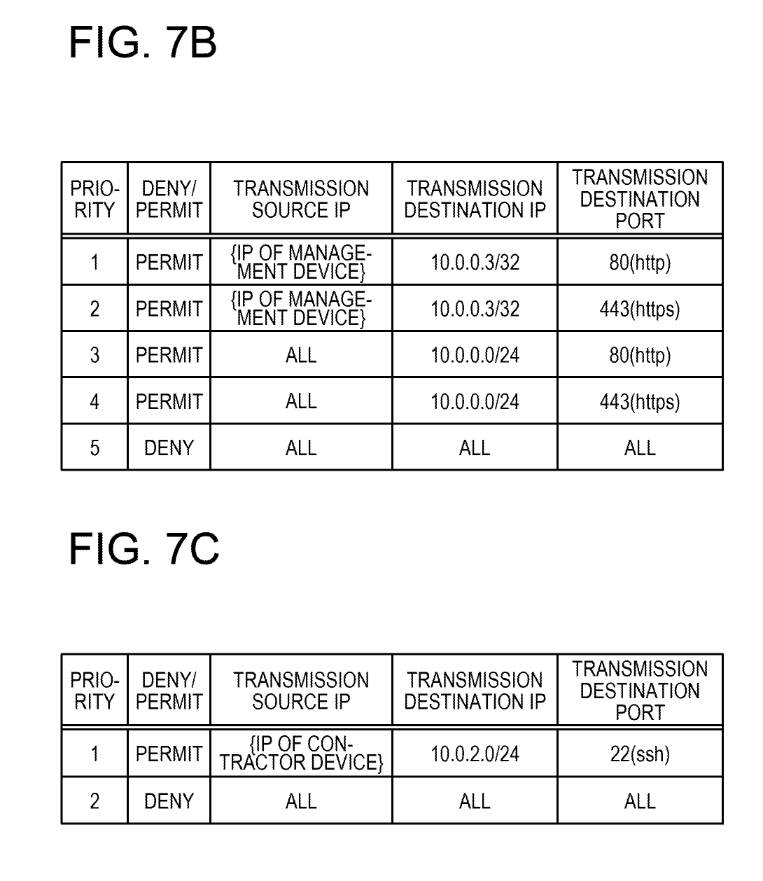

FIG. 7A is a diagram illustrating an example of a state where a communication with the platform is permitted or denied, according to Embodiment 1. The example of FIG. 7A represents a case where the example of FIG. 6A is changed to a setting of an operation stage at which the developed application software is operated to start a business. FIG. 7B is a table illustrating an example of setting information of the first firewall according to Embodiment 1. FIG. 7B represents setting information of conditions for permitting or denying a communication, which is set for the first firewall 60 of FIG. 7A. FIG. 7C is a table illustrating an example of setting information of the second firewall according to Embodiment 1. FIG. 7C represents setting information of conditions for permitting or denying a communication, which is set for the second firewall 70 of FIG. 7A.

In the setting information illustrated in FIG. 7B, the priority “3” is changed to a setting for permitting a communication from all addresses to the IP address “10.0.0.0/24” with the port number of the transmission destination “80.” Further, in the setting information illustrated in FIG. 7B, the priority “4” is changed to a setting for permitting a communication from all addresses to the IP address “10.0.0.0/24” with the port number of the transmission destination “443.”

The setting information illustrated in FIG. 7C has no difference from FIG. 6C. As for the priority “1,” the setting information illustrated in FIG. 7C stores the setting for permitting a communication from the IP address of the contractor terminal 13 to the IP address “10.0.2.0/24” with the port number of the transmission destination “22.” As for the priority “2,” the setting information illustrated in FIG. 7C stores the setting for denying communications with all port numbers from all transmission sources to all transmission destinations.

As a result, as illustrated in FIG. 7A, the management device 12, the contractor terminal 13, and the user terminal 14 may communicate with the web server 61, the AP server 62, and the MNG server 63 with the port numbers “80” and “443” via the first firewall 60.

In addition, the contractor terminal 13 may communicate with the spring server 71 with the port number “22.” Meanwhile, the management device 12 and the user terminal 14 are blocked from accessing the spring server 71 by the second firewall 70.

As a result, the contractor may conduct the business for providing the user with a service by operating the developed application software on the platform.

Process Flow

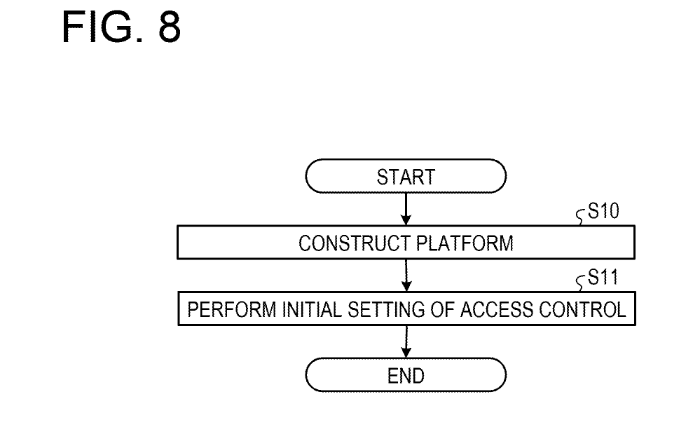

Next, descriptions will be made on a flow of a service providing process for constructing a platform in the cloud 10 by the management apparatus 12. FIG. 8 is a flowchart illustrating an example of the service providing process according to Embodiment 1. The service providing process is executed at a predetermined timing, for example, at the timing when the reception unit 41 receives the definition information on a construction of a platform.

The construction unit 42 constructs a platform in the cloud 10 according to the received definition information (step S10). For example, the construction unit 42 generates virtual machines as many as specified by the definition information, in the server device 11. Then, the construction unit 42 incorporates an OS or middleware corresponding to the type specified by the definition information into each of the generated virtual machines, so as to generate virtual machines each having the function corresponding to the specified type. The construction unit 42 constructs a virtual network according to the network configuration specified by the definition information, and generates a virtual system in which the generated virtual machines and the virtual network are combined with each other, as a platform.

The construction unit 42 performs an initial setting of the access control for the constructed platform based on the initial setting information 30 (step S11), and ends the process. For example, the construction unit 42 performs a setting for the firewall to permit an access from the address of the management device 12 which is stored as an access source to be initialized in the initial setting information 30, and block accesses from other addresses.

According to the present embodiment, when the definition information on a construction of a platform is received from the plurality of contractor terminals 13 via a network, the management device 12 constructs a plurality of platforms in the cloud 10. The management device 12 causes each of the plurality of constructed platforms to include a firewall initialized to block accesses excluding one or a plurality of common access sources. Thus, the management device 12 may suppress an inappropriate access to the platform.

In addition, the management device 12 sets one or a plurality of access sources common to the platform to the address of the management device 12 that controls the construction of the platform. Thus, the management device 12 may suppress an access to a platform from access sources other than the management device 12.

In addition, the management device 12 updates the one or the plurality of common access sources to the address of the development source of the application software, at the development stage of the application software to be operated on the platform. The management device 12 updates the setting of the firewall to a state where all accesses are permitted, at the operation stage for operating the developed application software on the platform. Thus, the development source may access the platform and develop the application software, at the development stage. Further, an ordinary user may access the platform at the operation stage.

In addition, when the setting screen 110 for setting blocking or permission of an access for the firewall is displayed, the management device 12 hides the initial setting. Thus, the management device 12 may suppress the leakage of the information of the initial setting. Further, the management device 12 may suppress change of the initial setting.

In addition, the management device 12 receives the definition information from the contractor terminal 13 which is an information processing apparatus belonging to the tenant. Thus, the management device 12 may construct a platform corresponding to the definition information for each tenant.

### Embodiment 2

Although an embodiment of the present disclosure has been described, the present disclosure may be implemented in various different forms other than the embodiment described above.

For example, in the embodiment described above, the contractor changes the access control of the firewall in the development stage and the operation stage. However, the present disclosure is not limited thereto. For example, the management device 12 receives and stores registration of an address of a development terminal used for development, from the contractor. Then, according to an instruction of switching to the development stage, the management device 12 may change the access control of the firewall to permit an access of the development terminal. In addition, according to an instruction of switching to the operation stage, the management device 12 may change the access control of the firewall to permit accesses of all addresses.

In the embodiment described above, as for the firewall, permission or denial of a communication is determined based on a transmission source, a transmission destination, and a type of the communication. However, the present disclosure is not limited thereto. For example, as for the firewall, permission or denial of a communication may be determined based on only a transmission source of the communication. In this case, the initial setting information 30 has only to store an address of an access source permitted for the communication.

In the embodiment described above, as for the initial setting, a setting for permitting a communication from the management device 12 is set in the initial setting information 30. However, the present disclosure is not limited thereto. For example, when there exists a terminal which is permitted to communicate with the constructed platform in the initial state, in addition to the management device 12, an address of the terminal may be stored in the initial setting information 30.

In the embodiment described above, the setting screen 110 hides the initial setting. However, the present disclosure is not limited thereto. For example, the display controller 40 may cause the setting screen 110 to hide a part of the initial setting. For example, the display controller 40 may cause the setting screen 110 to hide a part of the initial setting which affects the security, such as the address of the management device 12. In addition, when there exist a plurality of terminals which are permitted to communicate with the platform, the display controller 40 may cause the setting screen 10 to hide settings of some of the terminals. For example, when terminals permitted to communicate with the platform are registered in the initial setting information 30, in addition to the management device 12, the display controller 40 may cause the setting screen 110 to hide only the setting of the management device 12. In addition, whether to display or hide the initial setting on the setting screen 110 may be set. For example, the initial setting information 30 stores the setting of whether to display or hide the initial setting, for each condition of the access control for permitting a communication. The display controller 40 may cause the setting screen 110 to hide the condition of the access control which is set to be hidden in the initial setting information 30.

In the embodiment described above, the initial setting for permitting a communication is stored in the initial setting information 30. However, the present disclosure is not limited thereto. For example, as for the initial setting, when a communication from the management device 12 is permitted, the management device 12 may perform the initial setting of the access control for the firewall, to permit the communication from the address of the management address 12. In this case, the management device 12 needs to perform a display control to hide the setting for setting the address of the management device 12 as a transmission source on the setting screen 110.

Among the respective processes described in the embodiments, all or some of the processes described to be automatically executed may be manually performed. Alternatively, all or some of the processes described to be manually executed may be automatically performed by a known method. In addition, the process procedures, the control procedures, the specific names, and the information including various data or parameters described in the disclosure herein or the drawings may be arbitrarily changed unless otherwise specified.

In addition, each component of the respective illustrated devices is functionally conceptual and is not necessarily required to be configured physically as illustrated. That is, specific forms of distribution or integration of the respective devices are not limited to those illustrated. All or some of the devices may be configured to be functionally or physically distributed or integrated in arbitrary units depending on, for example, various loads or use conditions. In addition, all or some of the respective process functions executed in the respective devices may be implemented by a CPU and programs analyzed and executed in the CPU, or hardware by a wired logic.

System

Embodiments of the system according to the present disclosure have been described. Hereinbelow, an example of a hardware configuration of the management device 12 in each of the embodiments will be described. All or some of the various process functions executed in the respective devices may be implemented on a CPU (or a microcomputer such as an MPU or a micro controller unit (MCU)). In addition, all or some of the various process functions may be implemented on a program analyzed and executed in a CPU (or a microcomputer such as an MPU or an MCU) or on hardware by a wired logic. The various processes described in each of the embodiments above may be implemented by causing a computer to execute prepared programs. Thus, hereinbelow, descriptions will be made on an example of a computer executing programs having the same functions as those in the embodiments described above.

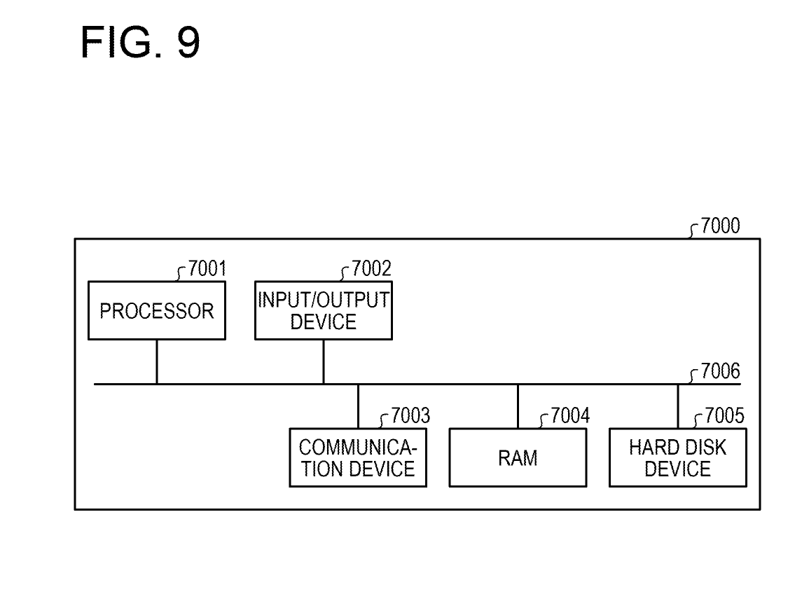

FIG. 9 is a diagram illustrating an example of a hardware configuration. The management device 12 may be implemented by a hardware configuration of a computer 7000 illustrated in FIG. 9. As illustrated in FIG. 9, the computer 7000 includes a processor 7001 for executing various arithmetic processes, an input/output device 7002, and a communication device 7003. Further, the computer 7000 includes a RAM 7004 that stores various pieces of information and a hard disk device 7005. The respective devices 7001 to 7005 are connected to a bus 7006.

The hard disk device 7005 stores service providing programs having the same functions as the respective process units, i.e., the display controller 40, the reception unit 41, the construction unit 42, and the changing unit 43 described in each of the embodiments above. Further, the hard disk device 7005 stores the initial setting information 30 and the platform setting information 31. The hard disk device 7005 stores various data for implementing the service providing programs.

The processor 7001 performs various processes by reading the respective programs stored in the hard disk device 7005, and developing and executing the programs in the RAM 7004. Further, the respective programs may cause the computer 7000 to function as the display controller 40, the reception unit 41, the construction unit 42, and the changing unit 43 described in each of the embodiments above. Further, the respective programs may not be necessarily stored in the hard disk device 7005. For example, the computer 7000 may read and execute the programs stored in a recording medium readable by the computer 7000.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiment(s) of the present disclosure has (have) been described in detail, it should be understood that the various changes, substitutions, and alterations could be made hereto without departing from the spirit and scope of the disclosure.

What is claimed is:

1. A non-transitory computer-readable recording medium having stored therein a program for causing a computer to execute a process of providing a service for constructing a platform in a cloud and using the constructed platform, the process comprising:
constructing a plurality of platforms in the cloud when definition information on a construction of a platform is received from a plurality of information processing devices via a network; and
causing each of the plurality of platforms constructed at the constructing to include a firewall initialized to block accesses excluding one or a plurality of common access sources.

2. The non-transitory computer-readable recording medium according to claim 1, wherein the one or a plurality of common access sources are an address corresponding to a control device that controls the construction of the platforms.

3. The non-transitory computer-readable recording medium according to claim 1, wherein the process further comprising:
updating the one or plurality of common access sources to an address of a development source of application software to be operated on the platforms at a development stage of the application software; and
updating a setting of the firewall to a state where all accesses are permitted, at an operation stage for operating the developed application software on the platforms.

4. The non-transitory computer-readable recording medium according to claim 1, wherein the process further comprising:
hiding the initial setting when a setting screen for setting blocking or permission of an access for the firewall is displayed.

5. The non-transitory computer-readable recording medium according to claim 1, wherein the plurality of information processing devices are information processing devices belonging to different tenants.

6. A method for providing a service for constructing a platform in a cloud and using the constructed platform, the method comprising:
constructing a plurality of platforms in the cloud when definition information on a construction of a platform is received from a plurality of information processing devices via a network; and
causing each of the plurality of constructed platforms to include a firewall initialized to block accesses excluding one or a plurality of common access sources.

7. A control device of a cloud for providing a service for constructing a platform in a cloud and using the constructed platform, the control device comprising:
a memory; and
a processor coupled to the memory and the processor configured to:
receive definition information on a construction of a platform from a plurality of information processing devices via a network; and
construct a plurality of platforms, in the cloud, each including a firewall initialized to block accesses excluding one or a plurality of common access sources according to the definition information.
